(19) United States
(12) Patent Application Publication
(10) Pub. No.: US 2014/0213437 A1
(43) Pub. Date: Jul. 31, 2014

(54) Gold-based catalysts for acetylene hydrochlorination

(71) Applicants: Guohua Luo, Beijing (CN); Kai Zhou, Beijing (CN); Wei Wang, Sodegaura, Chiba (JP); Fei Wei, Beijing (CN)

(72) Inventors: Guohua Luo, Beijing (CN); Kai Zhou, Beijing (CN); Wei Wang, Sodegaura, Chiba (JP); Fei Wei, Beijing (CN)

(73) Assignee: Tsinghua University, Beijing (CN)

(21) Appl. No.: 13/753,535

(22) Filed: Jan. 30, 2013

(51) Int. Cl. B01J 27/26; B01J 27/10

(52) U.S. Cl. CPC B01J 27/26; B01J 27/10
USPC 502/175; 502/225; 502/100; 502/180

(57) ABSTRACT

Powder catalysts that comprise particles of chemical compounds of Au and Cu deposited on acid-washed carbon-based supports are effective catalysts in ethyne hydrochlorination to produce vinyl chloride monomers (VCMs). They give a high selectivity and productivity of VCM and decreased amounts of the byproducts of chloroethane, dichloroethane and others. Thiocyanates are used as complexing agents to extend the catalyst lifetime. The activity of the catalyst is enhanced by doping nitrogen atoms into the support.

### CROSS-REFERENCE TO RELATED APPLICATIONS

Priority is claimed pursuant to 35 USC 119a,b from People's Republic of China patent application number 201210114021.7, filed on Apr. 17, 2012.

### TECHNICAL FIELD

This invention relates to the manufacture of powder catalysts for use in catalyzed hydrochlorination processes in which hydrogen chloride is added into an alkyne, which are useful for producing vinyl chloride monomers.

### BACKGROUND OF THE INVENTION

Polyvinyl chloride (PVC) is the second most used artificial resin in the world. The synthesis of vinyl chloride monomers (VCMs) is the heart of industrial PVC production. Two processes are presently used to prepare VCM. One is the pyrolysis of dichloroethane, which is produced by the addition reaction between ethylene and chlorine. The other process, sometimes also called the calcium carbide method, is the hydrochlorination of acetylene, which uses a HgCl₂ catalyst:

C₂H₂+HCl→CH₂CHCl

Over 70% of the VCM in China is produced by the hydrochlorination of acetylene because of the low cost of the process, and the presence of an abundant coal reserve in China makes acetylene a favored feedstock. However, highly volatile mercury-based catalysts are presently used in this process, which are toxic and very harmful to human health and the environment when they sublimate and are carried out into the atmosphere with the reactor effluent. The huge amount of heat released during the reaction leads to the generation of hot spots where the temperature can be as high as 210° C. This is because the catalyst is supported on activated carbon, which is poor in heat transfer. HgCl₂ easily vaporizes under this condition. For a fresh catalyst containing 10 to 15 wt % HgCl₂, the loss in the course of the reaction is over 75% of the HgCl₂ originally present. In addition to severe environment pollution, the Earth's mercury mineral resource could get exhausted if massive mining and consumption occurred.

The solution to these problems is to find a mercury-free catalyst for use in PVC manufacture. Some examples of a mercury-free catalyst that have been used are metal chlorides as the active components on an activated carbon support. One example is a catalyst reported by Deng (Polyvinyl Chloride, 1994, 6, 5-8), which used SnCl₂—BiCl₃—CuCl ternary chlorides as the active component. This catalyst could give 97% conversion of acetylene and 95% selectivity to PVC at 140° C., and its initial activity was nearly as good as that of the industrial mercury catalyst. However, although the catalyst was active enough, it had the serious problem that SnCl₂ is much more volatile than HgCl₂, such that 40 wt % of the SnCl₂ was lost after 12 hours and there was nearly 80 wt % loss after 48 hrs. Thus this catalyst is not stable enough for use in industrial application.

Japanese patents JP50082002-A and JP77012683-B granted to Taiyo Kaken Co. Ltd. taught the use of a catalyst that used one non-precious metal and SnCl₂ as the main active components. The catalyst was reported to be improved by heating it at 900° C. in an ammonia atmosphere for 6 h so that the nitrogen content was increased from 0.6 wt % to 3.2 wt %. The activity increases as the N content increased and the pretreatment-modified catalyst gave an improved acetylene conversion of from 98% to 99% and selectivity from 34% to 100% at a gas hourly space velocity (GHSV, acetylene based) of 50 h⁻¹. The catalyst pretreatment is an interesting new direction for catalyst improvement, but the stability and lifetime of the catalyst were not improved and these remained unacceptable for industrial use.

Chinese patents CN101497046 and CN201010226793.0 issued to Wei Fei and coworkers taught the use of a Cu—Bi—PO₄/SiO₂ catalyst and fluidized bed reactors. The catalyst was reported to give good initial conversion above 98% and a selectivity above 98% at GHSV=60 h⁻¹ and 200° C., but the catalyst suffered from severe coke accumulation and its activity rapidly decreased. Chinese patent CN201010226793.0 taught the use of an online regeneration method by feeding trace H₂O vapor and air separately to burn off the coke on the catalyst surface, by which means a regenerated catalyst could recover 99% activity. However, this requires a more complicated reactor.

Another recent class of catalyst used is a Au catalyst, which was reported by Hutchings and coworkers (Journal of Catalysis, 1985, 96, 292-295; Journal of Catalysis, 1991, 128, 378-386). They reported that a 1 wt % Au catalyst supported on activated carbon by the impregnation method gave 30% conversion at 180° C. and 870 h⁻¹. After regeneration by aqua regia, the regenerated catalyst had 22% initial activity. Although they reported that the Au catalyst gave the best C₂H₂ hydrochlorination activity among their catalysts tested, its lifetime was poor and the catalyst needed frequent regeneration. Another type of Au-based catalyst was described by Shen and coworkers (Catalysis Letters, 2010, 134, 102-109), who said that they coupled CuCl₂ with HAuCl₄ on activated carbon to decrease the needed Au content to 0.5 wt %, and they produced a catalyst that maintained over 99.5% conversion and selectivity during 200 h use at 160° C. and 50 h⁻¹. Although this academic work is interesting, its Au content is still very high for industrial use. Such high Au content will need a huge capital investment. This work also showed that researchers were aware of the necessity to decrease the Au content, but so far have only managed to reduce it to 0.5 wt %. Thus, although Au has been identified as a good catalyst, the problem of how to make the catalyst in a form that only needs a very small amount of Au still remains.

There remains a need for a commercially viable catalyst that is Hg-free for the production of VCM that has good activity and selectivity and long lifetime. The invented composition disclosed here is further directed towards decreasing the use of expensive components to produce a catalyst that is cheap enough for use in large quantities.

### BRIEF SUMMARY OF THE INVENTION

In accordance with an objective of this invention for a Hg-free catalyst, there is provided a chemical composition that is a catalyst of acetylene hydrochlorination comprising a catalyst support on which is deposited the chemical compounds of Au and at least one other metal from the group consisting of Cu, K, Na, Mg, Ce and La, wherein the amount of Au is not more than 0.50 wt %.

The chemical composition that is a catalyst of acetylene hydrochlorination wherein the catalyst support is activated carbon or carbon nanotubes.

The chemical composition that is a catalyst of acetylene hydrochlorination wherein the catalyst support comprises carbon nanotubes from at least one in the group consisting of single-walled carbon nanotubes, multi-walled carbon nanotubes and nitrogen-doped carbon nanotubes.

The chemical composition that is a catalyst of acetylene hydrochlorination wherein the amount of Au is between 0.1 and 0.5 wt %.

The chemical composition that is a catalyst of acetylene hydrochlorination wherein the chemical compounds comprise metal thiocyanates and metal chlorides.

The chemical composition that is a catalyst of acetylene hydrochlorination wherein the metals other than Au are at least one metal from the group consisting of Cu, K, Na, Mg, Ce and La, and the combined metal contents are between 0.1 and 5.0 wt %.

The chemical composition that is a catalyst of acetylene hydrochlorination wherein the chemical compounds are a mixture of metal thiocyanates and metal chlorides.

The chemical composition that is a catalyst of acetylene hydrochlorination wherein one of the metals other than Au is K, the Au content is between 0.1 and 0.5 wt %, and the K content is between 0.1 and 5.0 wt %.

The chemical composition that is a catalyst of acetylene hydrochlorination wherein the metals other than Au are at least one metal from the group consisting of Cu, K, Mg and La, and their combined metal contents are between 0.1 and 5.0 wt %.

The chemical composition that is a catalyst of acetylene hydrochlorination wherein the catalyst support is coconut shell activated carbon activated carbon.

The chemical composition that is a catalyst of acetylene hydrochlorination wherein the catalyst support is nitrogen-doped carbon nanotubes.

The chemical composition that is a catalyst of acetylene hydrochlorination wherein the chemical compounds are chloride and thiocyanate salts of Au, Cu and K, the Au content is between 0.1 and 0.5 wt %, and the contents of Cu and K together are between 0.1 and 5.0 wt %.

The chemical composition that is a catalyst of acetylene hydrochlorination wherein the metal compounds are HAuCl₄, CuCl₂ and KSCN, the Au content is between 0.1 and 0.5 wt %, the Cu content is between 0.1 and 2.0 wt %, and the K content is between 0.1 and 2.0 wt %.

### BRIEF DESCRIPTION OF THE DRAWINGS

FIG. 1 shows the conversion versus reaction time curve that measured the activity and stability of the catalyst in Example 1.

FIG. 2 shows the conversion versus reaction time curve that measured the activity and stability of the catalyst in Example 2.

FIG. 3 shows the conversion versus reaction time curves that measured the activities and stabilities of the catalysts in Examples 3 to 5.

FIG. 4 shows the conversion versus reaction time curves that measured the activities and stabilities of the catalysts in Examples 6 and 7.

FIG. 5 shows the conversion versus reaction time curves that measured the activities and stabilities of the catalysts in Examples 8 to 10.

FIG. 6 shows the conversion versus reaction time curves that measured the activities and stabilities of the catalysts in Examples 1(c) and 2(c).

### DETAILED DESCRIPTION OF THE INVENTION

The invented chemical compositions provide Hg-free catalysts for speeding up the hydrochlorination of acetylene reaction. The catalysts are of the supported form. Suitable support materials are high surface area carbon materials, which include activated carbon, carbon nanotubes and nitrogen-doped carbon nanotubes. Several metal-containing chemical compounds are deposited on these supports to form the catalyst. These metal compounds contain Au (gold) as the main active ingredient, can contain Cu (copper) as a second active ingredient, and contain compounds of alkali metals, alkaline earth metals or rare earth elements as promoters that protect the structural and chemical integrity of the active ingredients. These promoters are important components that help the catalyst maintain its catalytic action for long periods of time without significant loss in its activity, which would allow the use of less amounts of expensive active components.

The catalyst is made by depositing particles of the thiocyanate salts of the metals on a carbon support which has been acid washed prior to metal deposition. The promoters that have been found to be useful include various compounds of the alkali metals, alkaline earth metals, and rare earth metals. The alkali metals are preferably K (potassium) or Na (sodium). The alkaline earth metals are preferably Mg (magnesium) or Ca (calcium). The rare earth metals are preferably Ce (cerium) or La (lanthanum).

The correct choice of the support and the use of particles of gold and copper thiocyanate salts during deposition give nm scale particles which are uniformly dispersed on the support. The catalysts disclosed in the present invention have compositions, comprising the thiocyanate salts, and supports, which include nitrogen-doped carbon nanotubes, which are different from those previously used in the art.

The catalysts of the invention are conveniently prepared by the impregnation method that has been used with similar hydrochlorination catalysts in the art. Metal chlorides are used as precursors. These are dissolved in water to form a solution, and then thiocyanate salts are added by titration. After the solution has been stirred for 0.5 h, it is left to stand for several hours during which time water is evaporated. The preparation of the catalyst is completed by the calcination of the catalyst at an elevated temperature. Temperatures between 80° C. and 200° C. are the most suitable. The preparation does not need any special step.

The catalysts of the invention have high activity and stability in the concersion of acetylene (C₂H₂) and hydrogen chloride (HCl) into vinyl chloride monomer (CH₂═CHCl). Deactivation of a catalyst in the hydrochlorination process is known to occur in two ways: the active sites get covered by coke and the active sites get reduced by acetylene and hydrogen. The catalysts disclosed in the invention can inhibit coke formation and also slow down the reduction deactivation. These are due to the existence of the active ingredients as thiocyanate salts. Thus they have better stability than previous catalysts that have been used that are based on metal chloride salts. The catalysts have been verified to perform well under simulated industrial conditions using simulated rectant feed components and ratios and a reaction temperate of 180° C. The reactions can be run in a fixed bed or fluidized bed reactor.

The catalysts disclosed in the invention are very stable and selective even when the main active ingredient Au is present only in a very small amount. This is due to its use as the thiocyanate salt, which significantly inhibits the reduction of its metal ions by decreasing the electrode potentials. It is found that the adding of promoters can help maintain the Au compound as the thiocyanate salt. In addition, the adding of between 0.1 and 5.0 wt % of cerium or lanthanum chloride into the catalyst effectively decreases coke formation from acetylene, which slows down the deactivation caused by coke. By this manner of the design of the catalyst composition, the catalysts can maintain high activity even when the Au content is as low as 0.1 wt %. Thus, they are cheaper to produce.

The following examples are intended to illustrate the invention without limiting the scope thereof. Examples 1-10 are some preferred embodiments of the invention. Examples 1(C), 2(C) and 3(C) were used for comparison to show the superiority of the invented chemical compositions.

### Catalyst Manufacture

### Example 1

A 0.5 wt % Au catalyst was prepared by impregnation. An incipient wetness method was used with coconut shell activated carbon (AC) as the support. 0.045 g HAuCl₄.H₂O was weighed and dissolved in 5 ml deionized water to form a 25 mM aqueous solution. 0.124 g KSCN was dissolved in 4 ml water to form 319 mM solution. Then the KSCN solution was added into the Au solution dropwise under stirring at 25° C. This liquid mixture was used as the impregnating solution. 5 g AC was mixed with the liquid mixture. The paste formed was ground at 60° C. for 2 h and dried at 120° C. for 9 h in static air.

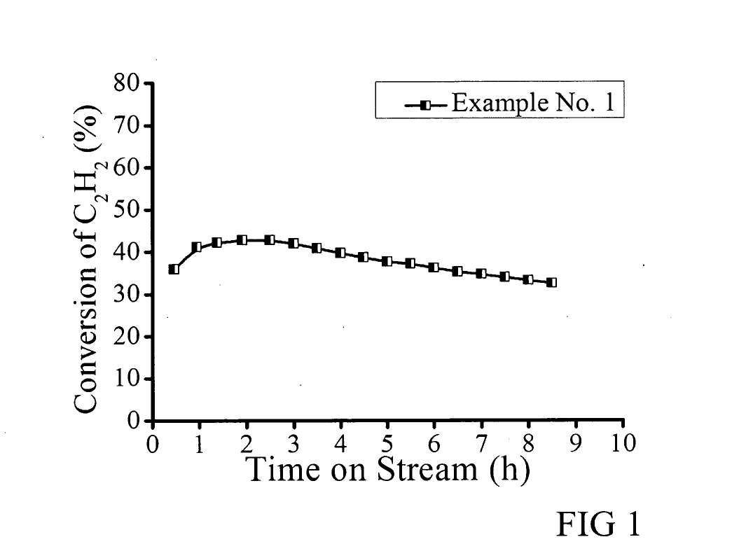

The catalytic action of the catalyst was tested with 0.15 g of the catalyst placed in a U-shaped silica tube, which was then heated at 120° C. and dried for 10 min by continuously feeding 10 sccm N₂. Activation was started by feeding 10 sccm HCl at 180° C. for 15 min. The reactions were carried out for the appropriate time at a total pressure of 1 atm and 180° C. The reactants were fed with a flow comprising HCl/C₂H₂/H₂: 6.6/6.0/0.5 (sccm), at 1200 h⁻¹ GHSV of acetylene (volume based). Gas analysis to measure the concentrations of N₂, C₂H₂, HCl and VCM was performed by gas chromatography using a thermal conductivity detector. The conversion of C₂H₂ was calculated by the gas analysis before and after the reaction. The time taken for a 10% decrease in conversion from the highest activity was used as the stability time. The selectivity of VCM was determined by a flame ionization detector (FID). The conversion versus reaction time curve is shown in FIG. 1, from which the following results were obtained:

| Example No. | Highest Conversion | Stability time | Selectivity |
|---|---|---|---|
| 1 | 42.8% | 5.6 h | >99% |

### Catalyst Manufacture

### Example 2

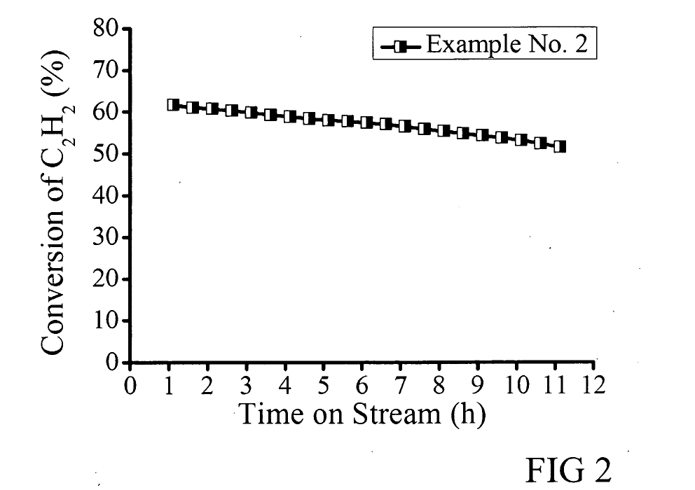

A 0.5 wt % Au catalyst containing 0.5 wt % Au and 1.0 wt % Cu was synthesized by adding 0.133 g CuCl₂.2H₂O (Beijing Chem.) into the 5 ml 25 mM HAuCl₄ aqua solution described in Example 1. The other details of the catalyst preparation procedure were the same as Example 1. The C₂H₂ hydrochlorination reaction and detection were also performed as described in Example 1. The conversion versus reaction time curve is shown in FIG. 2, from which the following results were obtained:

| Example No. | Highest Conversion | Stability time | Selectivity |
|---|---|---|---|
| 2 | 61.6% | 10 h | >99% |

### Catalyst Manufacture

### Examples 3-5

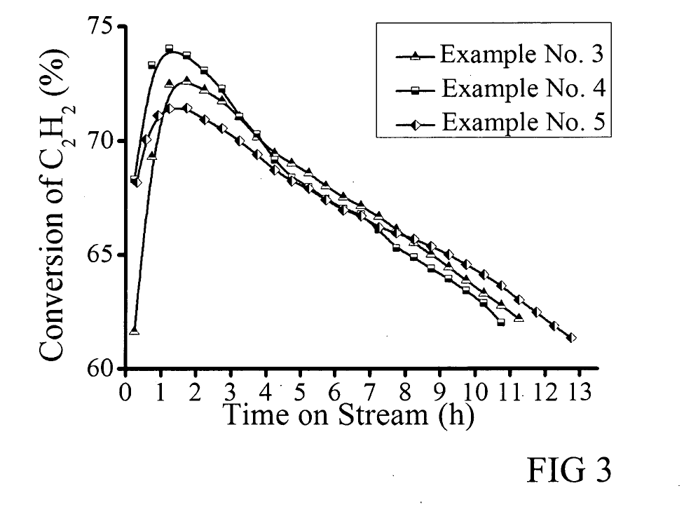

A series of 0.5 wt % Au catalyst containing 0.5 wt % Au and 1.0 wt % Cu were prepared, which further included 1 wt % La (Example 3), 1.0 wt % Mg (Example 4), and 1.0 wt % Ce (Example 5). These were synthesized by first adding 0.133 g CuCl₂.2H₂O into 5 ml 25 mM HAuCl₄ aqua solution as described previously. Examples 3, 4, and 5 were prepared, respectively, by then adding 0.134 g LaCl₃.7H₂O, 0.423 g MgCl₂.6H₂O, and 0.133 g CeCl₃.7H₂O. To each of these solutions were then added 4 ml 319 mM KSCN aqua solution. The other preparation details are the same as Example 1. C₂H₂ hydrochlorination reaction and detection were performed as described in Example 1. The conversion versus reaction time curves are shown in FIG. 3, from which the following results were obtained:

| Example No. | Highest Conversion | Stability time | Selectivity |
|---|---|---|---|
| 3 | 72.6% | 11.5 h | >99% |
| 4 | 73.7% | 9.75 h | >99% |
| 5 | 71.4% | 8 h | >99% |

### Catalyst Manufacture

### Examples 6-7

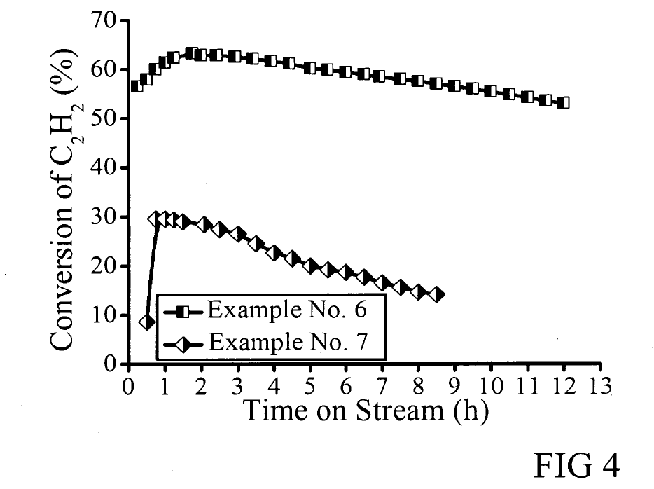

One catalyst containing 0.2 wt % Au and 0.4 wt % Cu (Example 6) and another catalyst containing 0.1 wt % Au and 0.2 wt % Cu (Example 7) were synthesized. Example 6 was made by adding 0.053 g CuCl₂.2H₂O into 5 ml 10 mM HAuCl₄ aqua solution which was then titrated with 4 ml 159 mM KSCN aqua solution. Example 7 was made by adding 0.027 g CuCl₂.2H₂O into 5 ml 5 mM HAuCl₄ aqua solution which was then titrated with 4 ml 80 mM KSCN aqua solution. The other preparation details were the same as Example 1. C₂H₂ hydrochlorination reaction and detection were performed as described in Example 1. The conversion versus reaction time curves are shown in FIG. 4, from which the following results were obtained:

| Example No. | Highest Conversion | Stability time | Selectivity |
|---|---|---|---|
| 6 | 61.63% | 9.5 h | >99% |
| 7 | 28.9% | 4.5 h | >99% |

### Catalyst Manufacture

### Examples 8-10

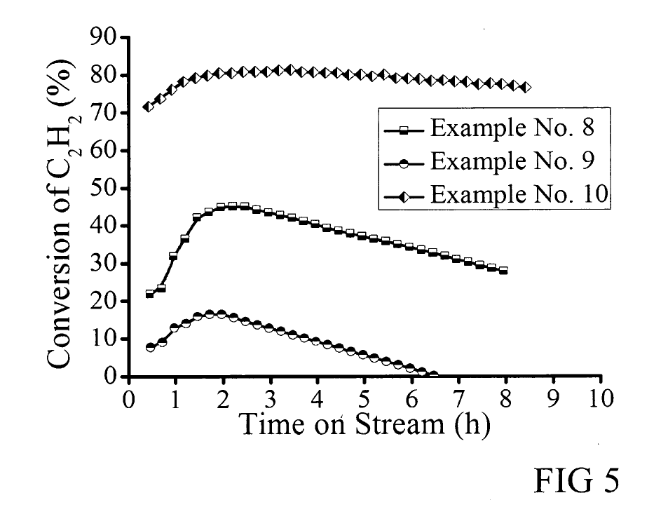

Catalysts containing 0.5 wt % Au and 1.0 wt % Cu were prepared as in Example 2 but with the support being changed to be N-CNTs (Example 8), MWCNTs (Example 9) or acid treated AC (Example 10). These were synthesized by the same preparation procedure as Example 2. C₂H₂ hydrochlorination reaction and detection were performed as described in Example 1. The conversion versus reaction time curves are shown in FIG. 5, from which the following results were obtained:

| Example No. | Highest Conversion | Stability time | Selectivity |
|---|---|---|---|
| 8 | 45.0% | 3.3 h | >99% |
| 9 | 16.5% | 3 h | >99% |
| 10 | 81.3% | 11.5 h | >99% |

### Catalyst Manufacture

### Examples 1(C)-2(C)

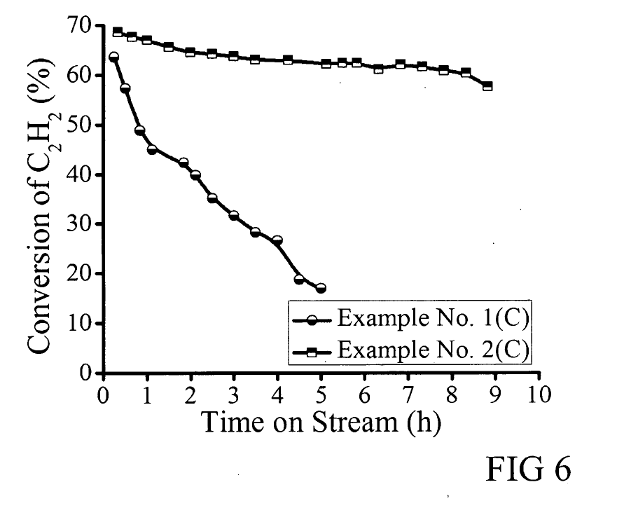

Two 0.5 wt % Au catalysts were prepared according to the procedures described in the prior art to compare with the activity and stability of the invented catalysts. Example 1(C) was prepared by adding 0.133 g CuCl₂.2H₂O into 5 ml 25 mM HAuCl₄ aqua solution to form a solution and then 5 g AC was mixed into the solution under stirring. Example 1(C), containing 0.5 wt % Au and 1.0 wt % Cu, was prepared by adding 0.133 g CuCl₂.2H₂O into 5 ml 25 mM Au(en)Cl₃ aqua solution, and then mixing 5 g AC into the solution under stirring. The other preparation details were the same as Example 1. C₂H₂ hydrochlorination reaction and detection were performed as described in Example 1. The conversion versus reaction time curves are shown in FIG. 6, from which the following results were obtained:

| Example No. | Highest Conversion | Stability time | Selectivity |
|---|---|---|---|
| 1(C) | 63.6% | 0.6 h | >99% |
| 2(C) | 67.6% | 8.5 h | >99% |

The Examples demonstrated that the catalysts of the invention, which contain no toxic metals and are mercury-free, are superior to the catalysts previously used in the prior art. In addition, the Au content used in the catalyst can be made lower than those previously used in the prior art. The catalyst can be further improved by using nitrogen-doped carbon nanotubes as the catalyst support, with this novel support giving notably better activity compared to the prior art supports previously used.

What is claimed is:

1. A chemical composition that is a catalyst of acetylene hydrochlorination comprising a catalyst support on which is deposited the chemical compounds of Au and at least one other metal from the group consisting of Cu, K, Na, Mg, Ce and La, wherein the amount of Au is not more than 0.50 wt %.

2. The chemical composition of claim 1 wherein the catalyst support is activated carbon or carbon nanotubes.

3. The chemical composition of claim 1 wherein the catalyst support comprises carbon nanotubes from at least one in the group consisting of single-walled carbon nanotubes, multi-walled carbon nanotubes and nitrogen-doped carbon nanotubes.

4. The chemical composition of claim 1 wherein the amount of Au is between 0.1 and 0.5 wt %.

5. The chemical composition of claim 1 wherein the chemical compounds comprise metal thiocyanates and metal chlorides.

6. The chemical composition of claim 1 wherein the metals other than Au are at least one metal from the group consisting of Cu, K, Na, Mg, Ce and La, and the combined metal contents are between 0.1 and 5.0 wt %.

7. The chemical composition of claim 1 wherein the chemical compounds are a mixture of metal thiocyanates and metal chlorides.

8. The chemical composition of claim 1 wherein one of the metals other than Au is K, the Au content is between 0.1 and 0.5 wt %, and the K content is between 0.1 and 5.0 wt %.

9. The chemical composition of claim 1 wherein the metals other than Au are at least one metal from the group consisting of Cu, K, Mg and La, and their combined metal contents are between 0.1 and 5.0 wt %.

10. The chemical composition of claim 1 wherein the catalyst support is coconut shell activated carbon.

11. The chemical composition of claim 1 wherein the catalyst support is nitrogen-doped carbon nanotubes.

12. The chemical composition of claim 1 wherein the chemical compounds comprise chloride and thiocyanate salts of Au, Cu and K, wherein the Au content is between 0.1 and 0.5 wt %, and the contents of Cu and K together are between 0.1 and 5.0 wt %.

13. The chemical composition of claim 1 wherein the chemical compounds are HAuCl₄, CuCl₂ and KSCN, the Au content is between 0.1 and 0.5 wt %, the Cu content is between 0.1 and 2.0 wt %, and the K content is between 0.1 and 2.0 wt %.
